(19) United States
(12) Patent Application Publication
(10) Pub. No.: US 2026/0229820 A1
(43) Pub. Date: Aug. 6, 2026

(54) CONNECTOR

(71) Applicant: SUMITOMO WIRING SYSTEMS, LTD., Mie (JP)

(72) Inventor: Kai FUJIWARA, Mie (JP)

(21) Appl. No.: 19/460,531

(22) Filed: Jan. 27, 2026

(30) Foreign Application Priority Data
Feb. 3, 2025 (JP) 2025-016122

(51) Int. Cl. H01R 13/629; H01R 13/518

(52) U.S. Cl. CPC H01R 13/62933; H01R 13/518

(57) ABSTRACT

To prevent split housings from coming off a frame before a connector is mated with a counterpart connector and improve operator workability, a connector is configured such that, when a lever is operated from a first operating angle to a second operating angle relative to a frame, second insertion grooves of a slide piece are displaced from first insertion grooves of the frame in a width direction and protrusions of split housings are prevented from coming out of the second insertion grooves. When the lever is at the second operating angle relative to the frame, mating between the split housings and a counterpart connector is allowed.

### CROSS-REFERENCE TO RELATED APPLICATIONS

This application is based on and claims priority from Japanese Patent Application No. 2025-016122, filed on February 3, 2025, with the Japan Patent Office, the disclosure of which is incorporated herein in its entirety by reference.

### TECHNICAL FIELD

The present disclosure relates to a connector including a plurality of split housings.

### BACKGROUND

JP 2009-087571 A describes a connector in which a plurality of split housings are accommodated in a frame. Such a connector can be mated with a counterpart connector by mating the split housings with mated portions included in the counterpart connector.

### SUMMARY

Some connectors have a structure in which the tips of the split housings protrude from the frame. In connectors having this structure, if a load is applied to the tip of a split housing, the split housing may come off the frame. For example, there is concern that a strong load may be applied to the tip of a split housing after assembly of the connector or during transportation of the assembled connector. Each time the split housing comes off the frame, the operator needs to reinsert the split housing into the frame, resulting in a decrease in workability. There is thus room for improvement in the structure of connectors including split housings.

A connector according to the present disclosure comprises: a plurality of split housings that are mateable with a counterpart connector on a front side in a front-rear direction; a frame including an accommodation space for accommodating the plurality of split housings arranged in a width direction that intersects the front-rear direction; a slide piece held slidably in the width direction relative to the frame; and a lever that slides the slide piece in the width direction, wherein the split housings are accommodated in the accommodation space with a front side to be mated with the counterpart connector protruding from the frame, the split housings include protrusions provided in an up-down direction, the frame includes first insertion grooves provided on a rear end side and extending in the front-rear direction, the slide piece includes second insertion grooves provided on a rear end side and extending in the front-rear direction, when the lever is at a first operating angle relative to the frame, the second insertion grooves match the first insertion grooves in position in the width direction, to allow the protrusions to be inserted into the first insertion grooves and the second insertion grooves and the split housings to be accommodated in the accommodation space, and when the lever is at a second operating angle relative to the frame, the second insertion grooves are displaced from the first insertion grooves in the width direction, to prevent the protrusions from coming out of the first insertion grooves and the second insertion grooves and allow the split housings to mate with the counterpart connector on the front side.

With the connector according to the present disclosure, it is possible to prevent the split housings from coming off the frame before the assembled connector is mated with the counterpart connector, thereby improving operator workability.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

FIG. 1 is a perspective view of a connector with part of split housings removed, as seen obliquely from the front.

FIG. 2 is a front view of the connector.

FIG. 3 is a perspective view of the connector as seen obliquely from the rear.

FIG. 4 is a perspective view of the connector with the split housings removed from the frame, as seen obliquely from the front.

FIG. 5 is a sectional view taken along section line A-A in FIG. 2, with the split housings omitted.

FIG. 6 is a sectional view taken along section line B-B in FIG. 2, with the split housings omitted.

FIG. 7 is a perspective view of a pair of slide pieces as seen obliquely from the front.

FIG. 8 is a sectional view taken along section line C-C in FIG. 2, with a lever in a first position.

FIG. 9 is a sectional view taken along section line C-C in FIG. 2, with the lever in a second position.

FIG. 10 is a sectional view taken along section line C-C in FIG. 2 with the lever in the second position, showing the half-mated state with a counterpart connector.

FIG. 11 is a sectional view taken along section line C-C in FIG. 2 with the lever in a third position, showing the mated state with the counterpart connector.

FIG. 12 is a sectional view taken along section line A-A in FIG. 2 with the lever in the third position, showing the mated state with the counterpart connector.

### DETAILED DESCRIPTION

In the following detailed description, reference is made to the accompanying drawings, which form a part hereof. The illustrative embodiments described in the detailed description, drawings, and claims are not meant to be limiting. Other embodiments may be utilized, and other changes may be made, without departing from the spirit or scope of the subject matter presented here.

### Description of Embodiments of the Present Disclosure

First, embodiments of the present disclosure will be listed and described.

[1] A connector according to an embodiment of the present disclosure comprises: a plurality of split housings that are mateable with a counterpart connector on a front side in a front-rear direction; a frame including an accommodation space for accommodating the plurality of split housings arranged in a width direction that intersects the front-rear direction; a slide piece held slidably in the width direction relative to the frame; and a lever that slides the slide piece in the width direction, wherein the split housings are accommodated in the accommodation space with a front side to be mated with the counterpart connector protruding from the frame, the split housings include protrusions provided in an up-down direction, the frame includes first insertion grooves provided on a rear end side and extending in the front-rear direction, the slide piece includes second insertion grooves provided on a rear end side and extending in the front-rear direction, when the lever is at a first operating angle relative to the frame, the second insertion grooves match the first insertion grooves in position in the width direction, to allow the protrusions to be inserted into the first insertion grooves and the second insertion grooves and the split housings to be accommodated in the accommodation space, and when the lever is at a second operating angle relative to the frame, the second insertion grooves are displaced from the first insertion grooves in the width direction, to prevent the protrusions from coming out of the first insertion grooves and the second insertion grooves and allow the split housings to mate with the counterpart connector on the front side.

With the connector having the above configuration, in the process of assembling the split housings to the frame, the operator sets the lever to the first operating angle relative to the frame. As a result, the second insertion grooves of the slide piece match the first insertion grooves of the frame in position in the width direction within the frame, allowing the protrusions of the split housings to be inserted into the first insertion grooves and the second insertion grooves and the split housings to be accommodated in the accommodation space. The operator then operates the lever from the first operating angle to the second operating angle. As a result, the second insertion grooves of the slide piece are displaced from the first insertion grooves of the frame in the width direction, thereby preventing the protrusions of the split housings accommodated in the accommodation space from coming out of the first insertion grooves and the second insertion grooves. When the lever is at the second operating angle relative to the frame, the slide piece is positioned to enable mating of the split housings with the counterpart connector on the front side. Thus, when the operator operates the lever from the first operating angle to the second operating angle and the split housings are assembled to the frame, the slide piece prevents the split housings from coming off the frame, and mating with the counterpart connector is allowed. Hence, the split housings are prevented from coming off the frame before the assembled connector is mated with the counterpart connector, with it being possible to improve operator workability.

[2] In the connector according to [1], the frame may include openings that are provided on a front end side and into which counterpart protrusions of the counterpart connector are to be inserted, the slide piece may include groove portions that are provided on a front end side and into which the counterpart protrusions are to be inserted, when the lever is at the second operating angle, the groove portions may match the openings in position in the width direction, to allow the counterpart protrusions to be inserted into the openings and the groove portions and the split housings to mate with the counterpart connector, and when the lever is moved from the second operating angle to a third operating angle relative to the frame, the groove portions may be displaced from the openings in the width direction while the first insertion grooves remain displaced from the second insertion grooves in the width direction, to prevent the counterpart protrusions from coming out of the openings and the groove portions. This enables the operator to, by simply operating the lever, simultaneously prevent the split housings from coming off the frame and maintain mating with the counterpart connector, thus further improving operator workability.

[3] In the connector according to [2], the lever may be rotatable in the front-rear direction about a rotation shaft provided on one end side in the width direction of the frame, the second operating angle may be larger than the first operating angle relative to the frame based on the width direction, and the third operating angle may be larger than the first operating angle and smaller than the second operating angle based on the width direction. Thus, after the split housings are assembled to the frame, the operating direction of the lever in the process of mating the connector with the counterpart connector is opposite to the direction in the case of assembling the split housings to the frame. As a result, the operator can easily distinguish the operating direction of the lever in each process and operate intuitively.

[4] In the connector according to [3], the slide piece may include: a plate-shaped portion extending in the width direction and provided with the second insertion grooves on the rear end side and the groove portions on the front end side; and an engagement groove extending from the plate-shaped portion in the front-rear direction, and the lever may include an engagement shaft that slidably engages with the engagement groove to convert rotation of the lever about the rotation shaft into sliding motion of the plate-shaped portion in the width direction. With this configuration, in the process of mating the connector with the counterpart connector after the split housings are assembled to the frame, the slide piece slides in the opposite direction according to the operating direction of the lever and by an amount corresponding to a different operating angle. Therefore, when operating the lever from the second operating angle to the third operating angle, both the displacement in the width direction between the second insertion grooves and the first insertion grooves and the displacement in the width direction between the groove portions and the openings can be achieved without increasing the dimension in the width direction of the plate-shaped portion of the slide piece. This suppresses an increase in the dimension in the width direction of the plate-shaped portion, and consequently suppresses an increase in the size of the connector.

[5] In the connector according to any of [2] to [4], the frame may include a lever locking portion that locks the lever operated to the third operating angle. This prevents the lever from returning from the third operating angle to the second operating angle, thereby preventing de-mating from the counterpart connector.

[6] In the connector according to any of [1] to [4], the frame may include lock arms that engage with the split housings accommodated in the accommodation space. Thus, the split housings accommodated in the accommodation space of the frame are held not only by the slide piece but also by engagement with the lock arms, and therefore are more securely prevented from coming off the frame.

### Details of Embodiments of the Present Disclosure

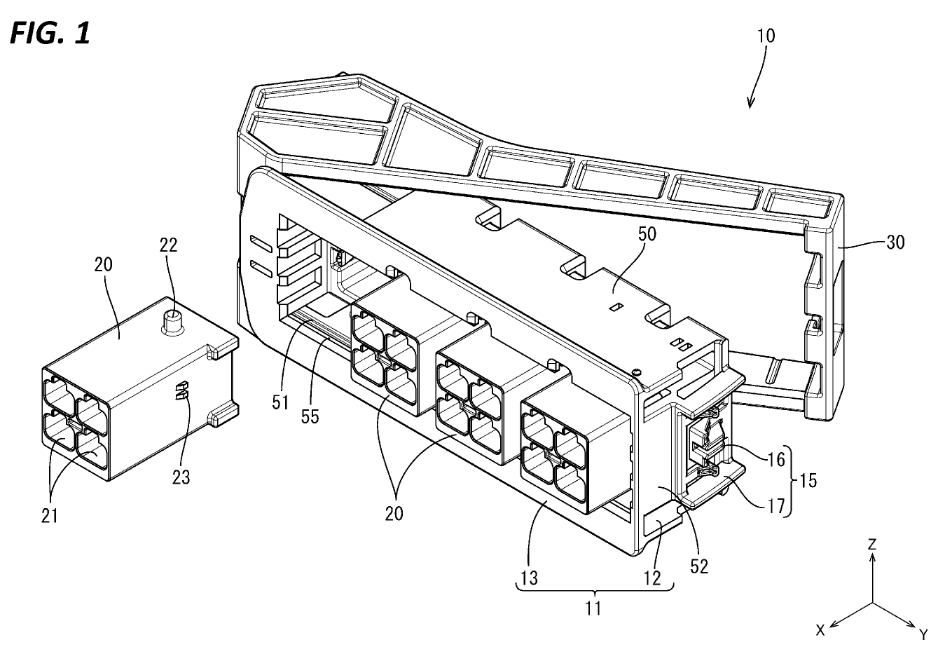

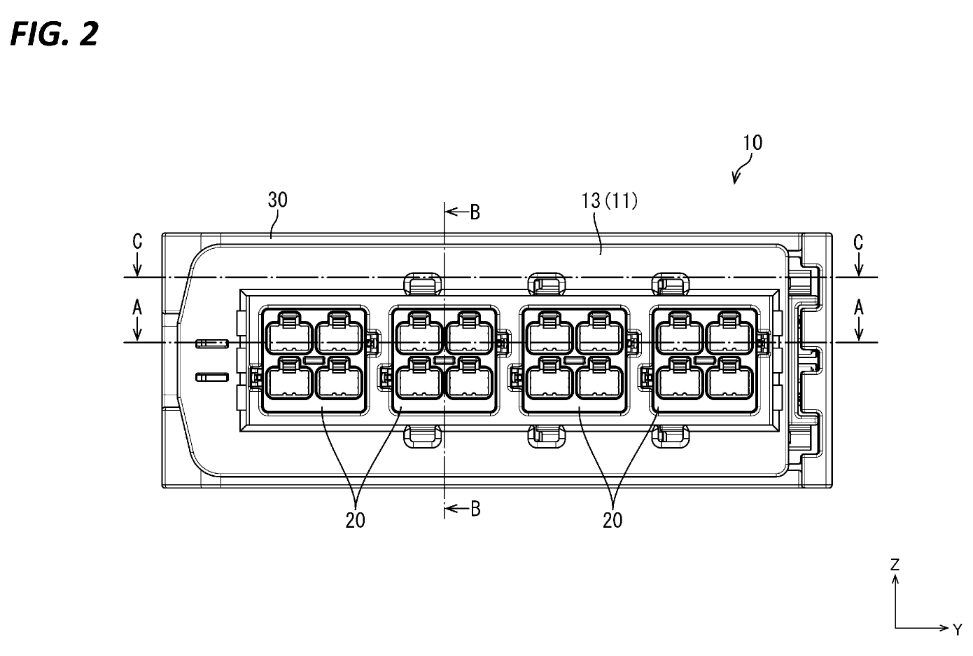

Embodiments of the present disclosure will be described below with reference to FIGS. 1 to 12. The present disclosure is not limited to these examples, but is defined by the claims and intended to include all modifications within the meaning and scope equivalent to the claims. In each drawing, some parts of the configurations may be exaggerated or simplified for the sake of explanation.

In the following description, the direction indicated by arrow X is referred to as the "front-rear direction X," the direction indicated by arrow Y as the "width direction Y," and the direction indicated by arrow Z as the "up-down direction Z." For a plurality of identical members, reference numerals may be assigned to only some of the members and omitted for the other members.

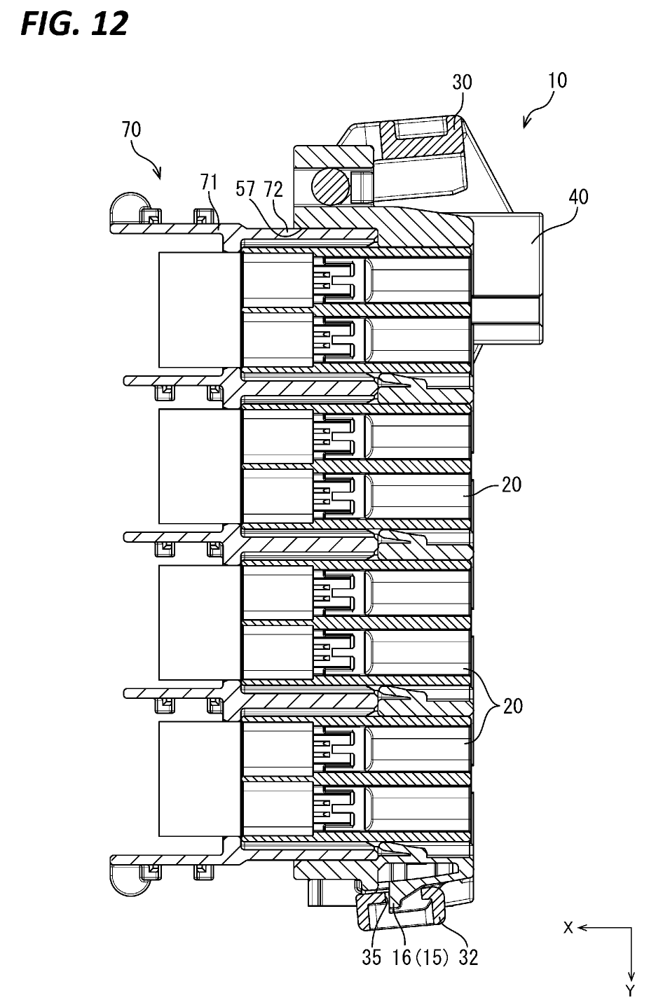

As shown in FIG. 1, a connector 10 mainly includes four split housings 20, a frame 11 that holds the split housings 20, and a lever 30. As shown in FIG. 12, the connector 10 is mateable with a counterpart connector 70 on the front side.

As shown in FIG. 12, the counterpart connector 70 that mates with the connector 10 includes a counterpart housing 71 made of synthetic resin. The counterpart housing 71 is tubular with a front opening, and its tip forms a counterpart mating portion 72 that mates with the connector 10. In a state in which the connector 10 is mated with the counterpart connector 70, the counterpart mating portion 72 is accommodated within a mating space 57 provided on the front side of the connector 10, and the tips of the split housings 20 are inserted into the counterpart mating portion 72, establishing mating between the two connectors.

As shown in FIG. 1, each split housing 20 has an approximately block shape, and includes four terminal accommodation portions 21 for accommodating terminals. In this embodiment, the split housing 20 has two terminal accommodation portions 21 arranged in each of the width direction Y and the up-down direction Z. Each of the upper and lower parts of the split housing 20 is provided with a protrusion 22. The protrusions 22 are inserted into insertion grooves of each of the frame 11 and slide piece 40, as described later. In this embodiment, the protrusions 22 are located at the rear end side of the split housing 20. Engaged portions 23 protruding in the width direction Y are provided at both ends in the width direction Y of the split housing 20. The engaged portions 23 engage with lock arms 54 provided in the frame 11, as described later.

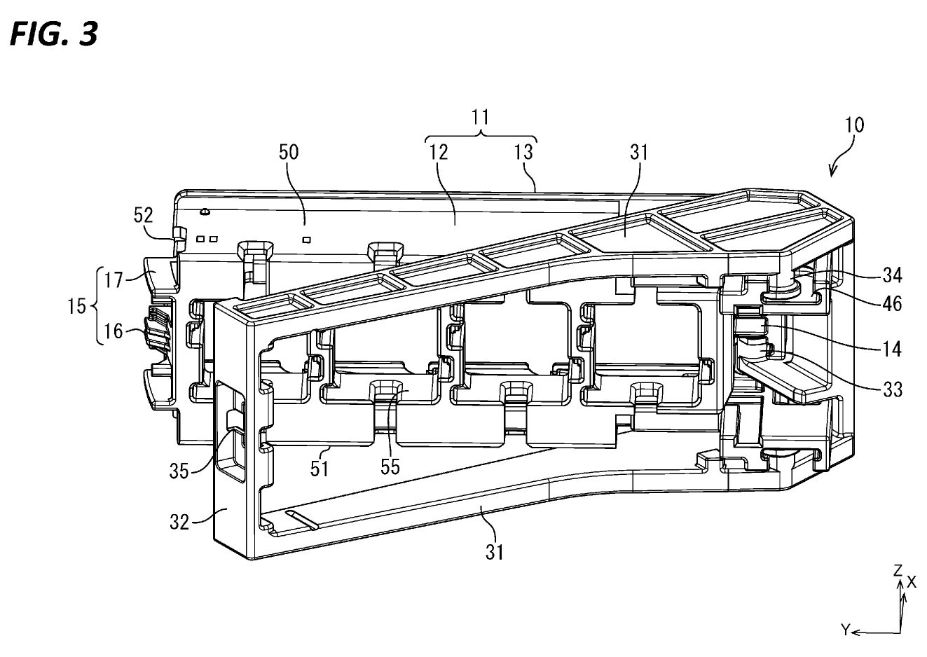

The frame 11 is made of synthetic resin, and includes a block-shaped frame body 12 and a flange portion 13 protruding outward from the front end side of the frame body 12, as shown in FIGS. 1, 2, 3, 4, and 5. The frame body 12 has a hollow rectangular parallelepiped shape with an accommodation space 55 extending through in the front-rear direction X. As shown in FIGS. 1 and 3, the frame body 12 includes an upper wall portion 50 and a lower wall portion 51 arranged at a predetermined distance apart in the up-down direction Z, and a pair of side wall portions 52 connecting the upper wall portion 50 and the lower wall portion 51. The space surrounded by the upper wall portion 50, the lower wall portion 51, and the pair of side wall portions 52 in the frame body 12 is the accommodation space 55.

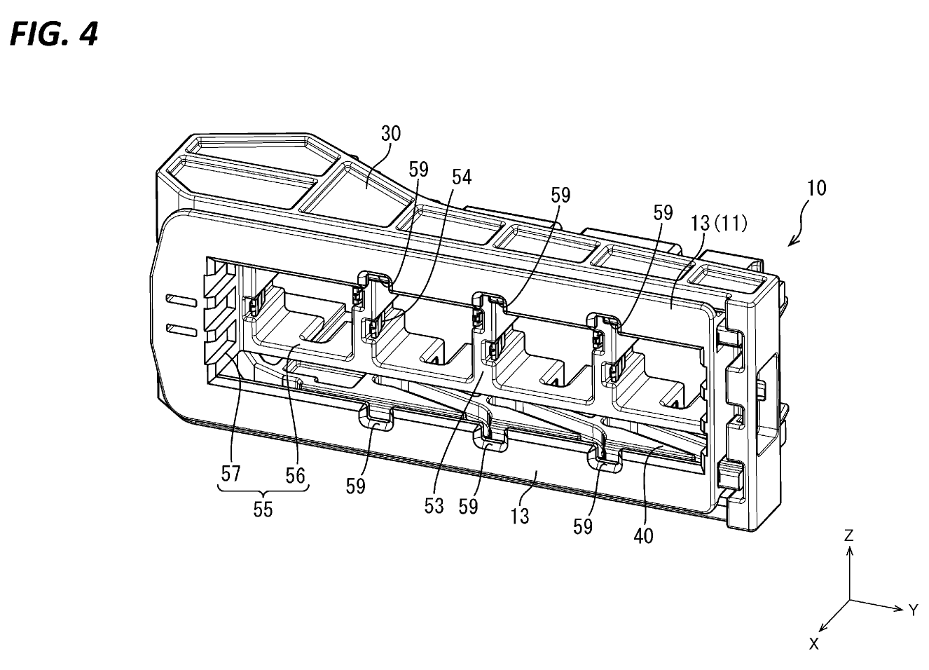

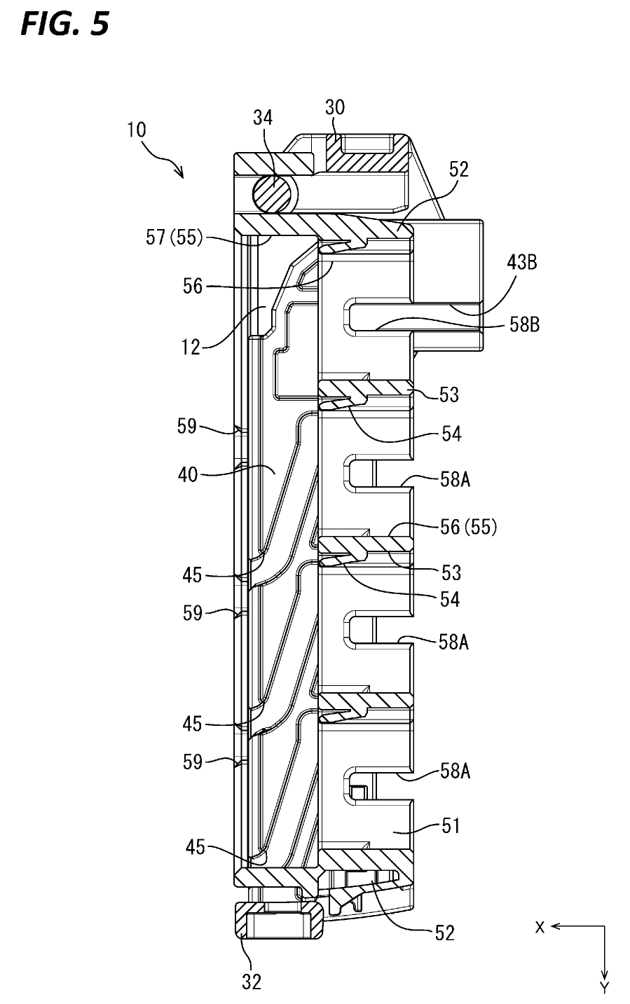

As shown in FIGS. 4 and 5, the accommodation space 55 includes four housing holding spaces 56 for individually holding the split housings 20, and a mating space 57 into which the counterpart mating portion 72 of the counterpart connector 70 is inserted and mated. Each housing holding space 56 is located on the rear side in the frame body 12, and has an opening corresponding to the outer shape of the split housing 20. Specifically, inside the frame body 12, three partition wall portions 53 are arranged between the side wall portions 52 on the rear side in the front-rear direction X. The partition wall portions 53 and the pair of side wall portions 52 define the housing holding spaces 56.

The side wall portions 52 and the partition wall portions 53 defining the housing holding spaces 56 are provided with lock arms 54 extending in the front-rear direction X. Each lock arm 54 is composed of a piece that is flexurally deformable in the width direction Y in the housing holding space 56. Hence, in the case where the split housing 20 is inserted from the rear side of the frame 11 into the housing holding space 56, the lock arm 54 engages with the engaged portion 23 of the split housing 20, with it being possible to hold the split housing 20 within the housing holding space 56. As shown in FIG. 4, the lock arms 54 provided within the same housing holding space 56 differ in position in the up-down direction Z.

The mating space 57 is located forward of the housing holding spaces 56 inside the frame body 12. The mating space 57 communicates with the four housing holding spaces 56 on the rear side. The split housings 20 have their front sides located in the mating space 57 and their rear sides held in the respective housing holding spaces 56.

As shown in FIG. 5, a plurality of first insertion grooves 58 extending in the front-rear direction X are provided at the rear end of the frame body 12. Each first insertion groove 58 is a groove into which the protrusion 22 of the corresponding split housing 20 is inserted, and is provided in the upper wall portion 50 and the lower wall portion 51 of the corresponding housing holding space 56 in the frame body 12. In this embodiment, the frame body 12 is provided with four first insertion grooves 58A and 58B. The first insertion grooves 58A correspond to the below-described second insertion grooves 43A provided in the slide piece 40, and the first insertion groove 58B corresponds to the below-described second insertion groove 43B provided in the slide piece 40.

As shown in FIG. 4, a plurality of openings 59 extending in the front-rear direction X are provided at the front end of the flange portion 13 in the frame 11. Each opening 59 is a groove into which the corresponding counterpart protrusion 73 of the counterpart connector 70 is inserted, and is located at a position corresponding to the edge of the opening of the mating space 57 in the flange portion 13. Specifically, in the flange portion 13, three openings 59 are provided at positions corresponding to the upper opening edge of the mating space 57, and three openings 59 are provided at positions corresponding to the lower opening edge of the mating space 57.

As shown in FIG. 3, a rotation shaft holding portion 14 that rotatably holds the rotation shaft 33 of the lever 30 is provided on one end side in the width direction Y of the frame body 12. A lever locking portion 15 that locks the lever 30 in a state in which mating with the counterpart connector 70 is completed is provided on the other end side in the width direction Y of the frame body 12. The lever locking portion 15 includes a locking piece 16 protruding in the width direction Y and a guide piece 17 for guiding the lever 30, at the side wall portion 52 of the frame body 12. The locking piece 16 and the guide piece 17 are located on the rear side of the side wall portion 52, and accordingly lock the lever 30 when the lever 30 is at the below-described third operating angle.

The lever 30 is rotated about one end in the width direction of the frame 11 as the rotation center. As shown in FIG. 3, the lever 30 includes a pair of arm portions 31 extending in the width direction and a connecting portion 32 connecting the pair of arm portions 31. At the ends of the pair of arm portions 31 not connected to the connecting portion 32, the rotation shaft 33 extends inward from the arm portions 31 in the up-down direction Z. The rotation shaft 33 is rotatably held by the rotation shaft holding portion 14 of the frame body 12 described above, thus enabling the lever 30 to rotate in the front-rear direction X about the rotation shaft 33. In more detail, the lever 30 is rotatable in the front-rear direction X about the rotation shaft 33, on the side rearward from the flange portion 13 (i.e., the front end) of the frame 11.

Each arm portion 31 is provided with an engagement shaft 34 extending inward in the up-down direction Z, on the side rearward from the rotation shaft 33. The engagement shaft 34 slidably engages with the below-described engagement groove 46 of the slide piece 40, thereby converting the rotating motion of the lever 30 about the rotation shaft 33 into the sliding motion of the slide piece 40 in the width direction Y.

The connecting portion 32 of the lever 30 is provided with a lever-side locked portion 35 that is locked by the lever locking portion 15 of the frame body 12. The lever-side locked portion 35 serves to lock the lever 30 to the frame body 12 when the lever 30 is operated to the below-described third operating angle. In this embodiment, the lever-side locked portion 35 is formed by an opening into which the locking piece 16 of the lever locking portion 15 is inserted.

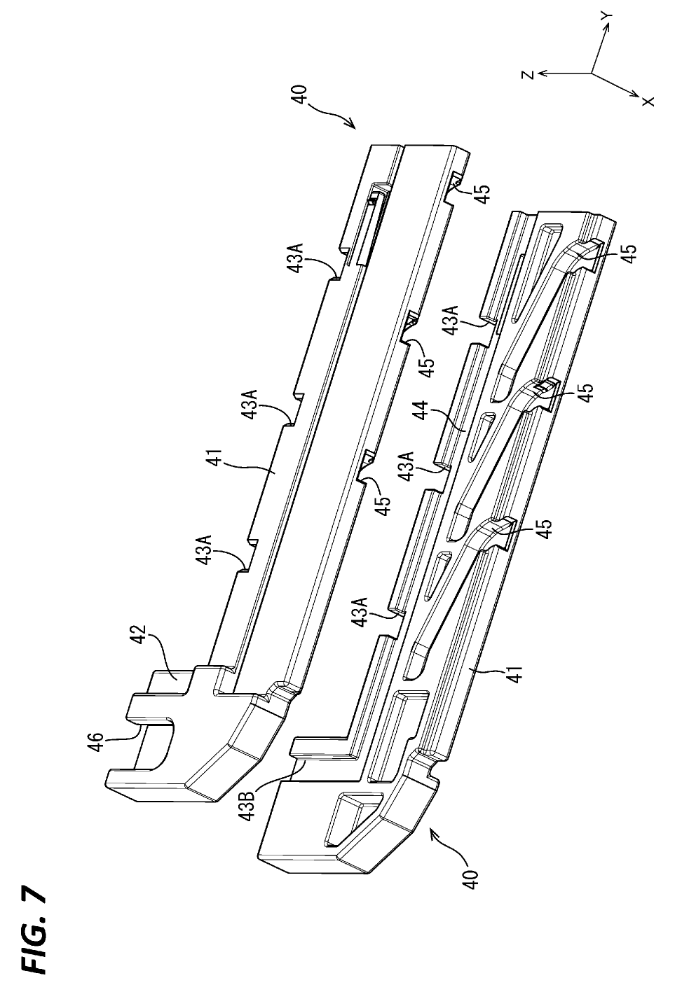

In the connector 10 having the above configuration, each split housing 20 is accommodated in the accommodation space 55 with its tip protruding from the front side of the frame 11, as shown in FIG. 1. Therefore, if an external load is applied to the split housing 20, the split housing 20 may come off the frame 11. For example, there is concern that a strong load may be applied to the tip of the split housing 20 after assembly of the connector 10 or during transportation of the assembled connector 10. Each time the split housing 20 comes off the frame 11, the operator needs to reinsert the split housing 20 into the frame 11, resulting in a decrease in workability. In view of this, in the connector 10, a pair of slide pieces 40 that slide in the width direction Y according to the operation of the lever 30 is provided inside the frame 11 (see FIG. 7). The grooves provided in the slide pieces 40 prevent the split housings 20 from coming off the frame 11.

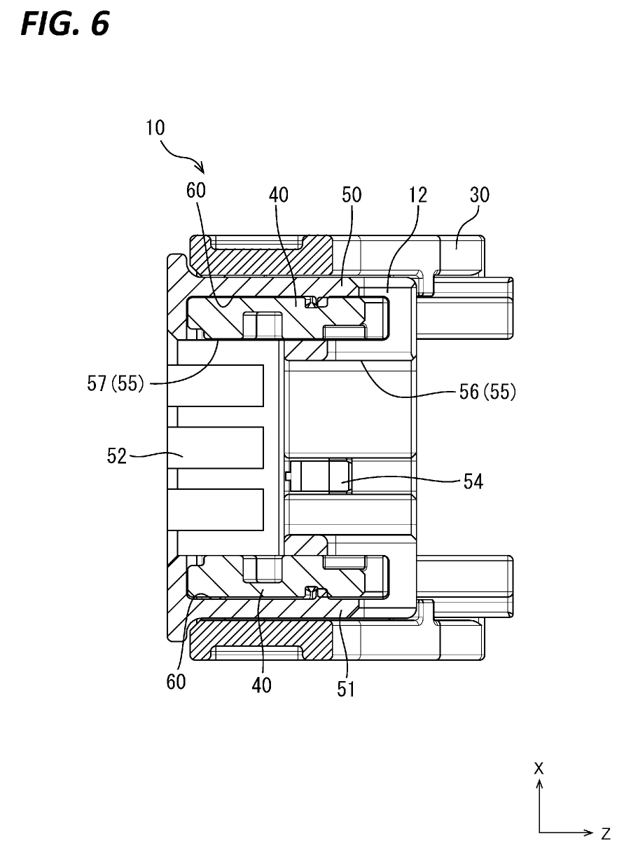

As shown in FIG. 6, the inside of the upper wall portion 50 and the lower wall portion 51 in the frame body 12 is hollow, forming slide piece holding spaces 60 for holding the slide pieces 40 so as to be slidable in the width direction Y. The slide piece holding spaces 60 extend in the width direction Y inside the upper wall portion 50 and the lower wall portion 51. In the frame body 12, the lower surface on the front side of the upper wall portion 50 and the upper surface on the front side of the lower wall portion 51 are open, exposing the below-described cam grooves 45 of the slide pieces 40 held in the slide piece holding spaces 60.

As shown in FIG. 7, the slide pieces 40 held in the slide piece holding spaces 60 each include a plate-shaped portion 41 extending in the width direction Y within the frame body 12, and a rearward protruding piece portion 42 extending from the plate-shaped portion 41 in a crossing direction. Second insertion grooves 43 extending in the front-rear direction X are provided at the rear end of the plate-shaped portion 41. The second insertion grooves 43 correspond to the first insertion grooves 58 of the frame body 12. In this embodiment, three second insertion grooves 43A arranged in the width direction Y are provided at the rear end of the plate-shaped portion 41, and one second insertion groove 43B is provided in the rearward protruding piece portion 42.

A holding groove 44 extending in the width direction Y and communicating with the four second insertion grooves 43 is provided on the back surface side of the plate-shaped portion 41. The holding groove 44 holds the protrusions 22 of the split housings 20 inserted into the respective second insertion grooves 43 so as to be slidable in the width direction Y.

Cam grooves 45 that extend in the front-rear direction X and into which the counterpart protrusions 73 of the counterpart connector 70 are inserted are provided at the front end of the plate-shaped portion 41. In this embodiment, three cam grooves 45 arranged in the width direction Y are provided at the front end of the plate-shaped portion 41. The cam grooves 45 correspond to the openings 59 of the frame body 12. The counterpart protrusions 73 inserted into the cam grooves 45 are held slidably inside the cam grooves 45 according to the sliding motion of the slide piece 40.

An engagement groove 46 that extends in the front-rear direction X and engages with the engagement shaft 34 of the lever 30 is provided on the surface of the rearward protruding piece portion 42. Hence, rotating the lever 30 about the rotation shaft 33 changes the position in the width direction Y of the engagement shaft 34 within the engagement groove 46, thereby sliding the slide piece 40 in the width direction Y.

### Assembly of Split Housings

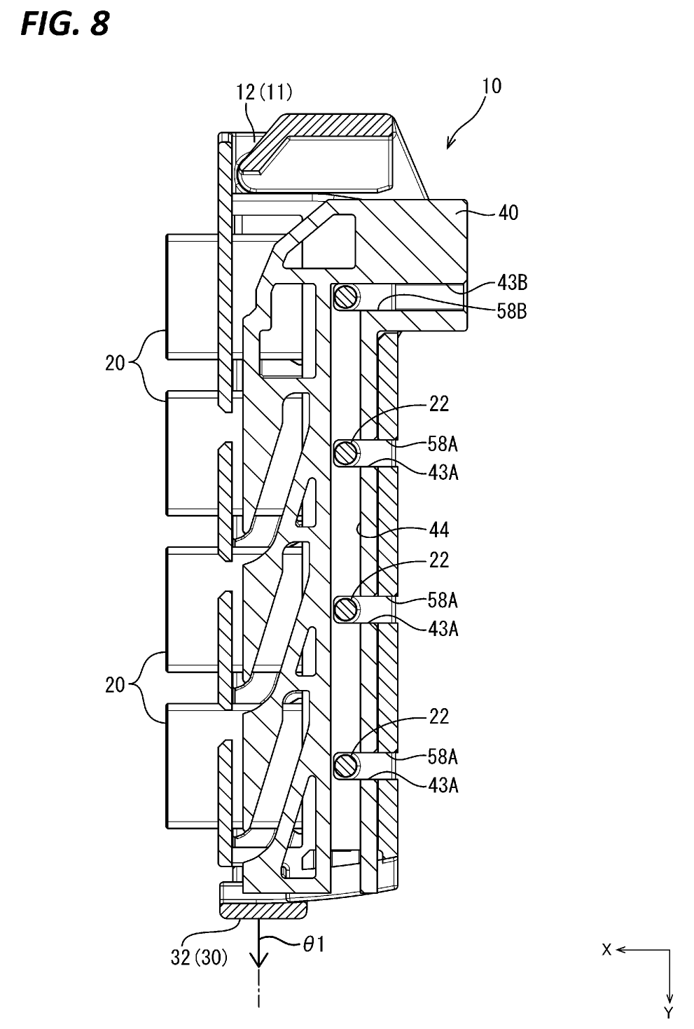

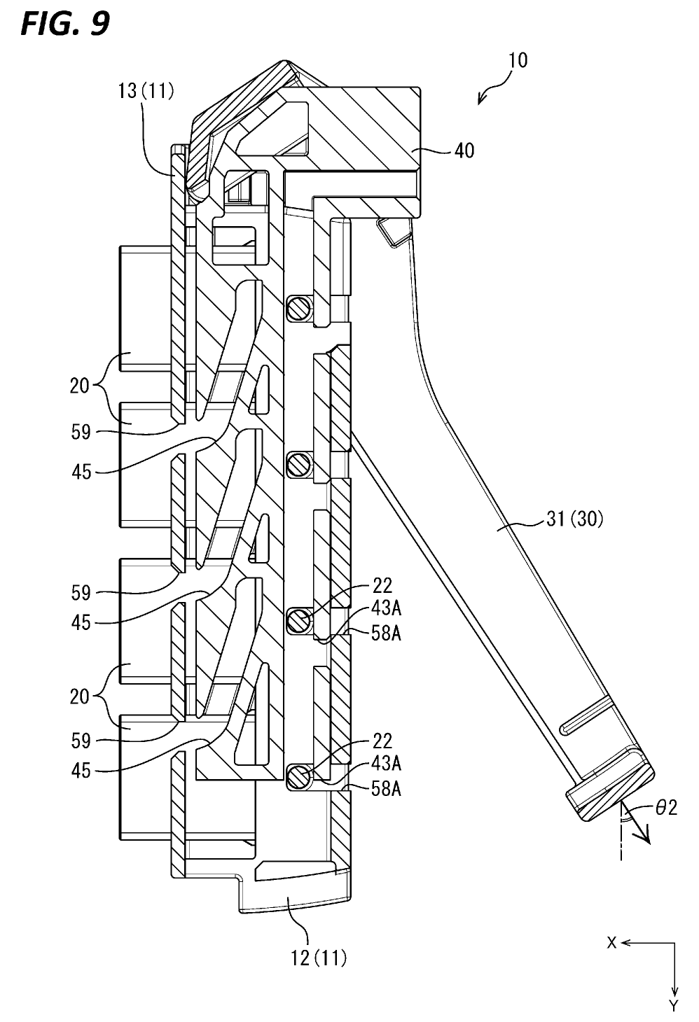

Next, a process of assembling the split housings 20 to the frame 11 will be described with reference to FIGS. 8 and 9. First, the lever 30 is operated to a first operating angle relative to the frame 11, to set each slide piece 40 to a first position. The first operating angle is indicated as θ1 in FIG. 8. In the first position, the second insertion grooves 43 of the slide piece 40 match the first insertion grooves 58 of the frame 11 in position in the width direction Y within the frame 11. This allows the protrusions 22 of the split housings 20 to be inserted into the first insertion grooves 58 and the second insertion grooves 43 from the rear side of the frame 11.

In this embodiment, the first operating angle is the angle when the lever 30 is rotated such that a line segment passing through the rotation shaft 33 and an approximate center in the front-rear direction X of the connecting portion 32 is approximately 0 degrees relative to the width direction Y (indicated as θ1 in FIG. 8).

Each split housing 20 is inserted into the corresponding housing holding space 56 from the rear side of the frame 11. Since the opening of each first insertion groove 58A of the frame 11 is located forward of each second insertion groove 43A, the protrusion 22 of the split housing 20 is inserted from the first insertion groove 58A into the second insertion groove 43A of the slide piece 40. Moreover, since the opening of the second insertion groove 43B of the slide piece 40 is located forward of the first insertion groove 58B, the protrusion 22 is inserted from the second insertion groove 43B into the first insertion groove 58B of the slide piece 40. As a result, the split housings 20 are accommodated in the accommodation space 55. In addition, the engaged portions 23 of the split housings 20 engage with the lock arms 54 provided in the housing holding spaces 56, thereby locking the split housings 20 within the accommodation space 55.

In a state in which each split housing 20 is accommodated in the accommodation space 55, the lever 30 is operated from the first operating angle to a second operating angle indicated as θ2 in FIG. 9 relative to the frame 11, to set each slide piece 40 to a second position. As shown in FIG. 9, in response to the rotation of the lever 30, the slide piece 40 slides in the width direction Y within the frame body 12, causing the second insertion grooves 43 to be displaced from the first insertion grooves 58 in the width direction Y. At this time, the protrusions 22 of the split housings 20 are slidably held in the holding groove 44 provided in the slide piece 40, in response to the sliding motion of the slide piece 40. As a result of each second insertion groove 43 being displaced from the corresponding first insertion groove 58 in the width direction Y, the protrusion 22 of the split housing 20 can be prevented from coming out of the first insertion groove 58 and second insertion groove 43.

In this embodiment, the second operating angle is the angle when the lever 30 is rotated such that the line segment passing through the rotation shaft 33 and the approximate center in the front-rear direction X of the connecting portion 32 is approximately 45 degrees relative to the width direction Y (indicated as θ2 in FIG. 9). Therefore, when assembling the split housings 20 to the frame 11, the lever 30 is pulled out from the front side relative to the frame 11.

In a state in which the lever 30 is held at the second operating angle relative to the frame 11, the cam grooves 45 of the slide piece 40 match the openings 59 of the frame 11 in position in the width direction Y at the front end of the frame 11, as shown in FIG. 9. This allows the counterpart protrusions 73 of the counterpart connector 70 to be inserted into the cam grooves 45 through the openings 59 in the connector 10.

### Mating with Counterpart Connector

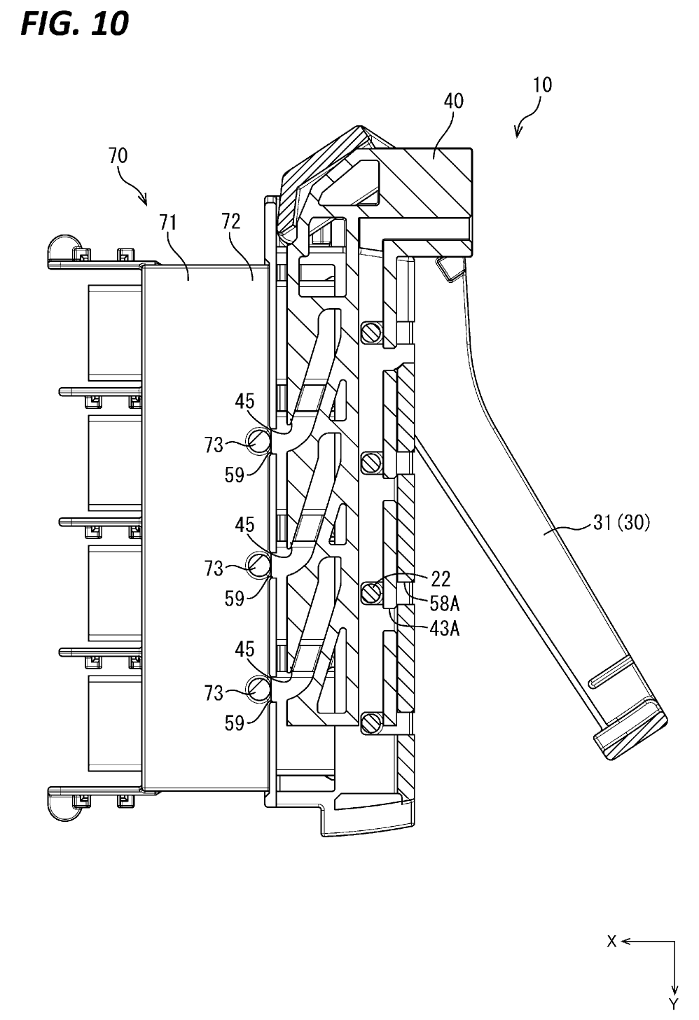

Next, a process of mating the connector 10 with the counterpart connector 70 will be described with reference to FIGS. 10 to 12. As shown in FIG. 10, in a state in which the lever 30 is held at the second operating angle relative to the frame 11, the tip of the counterpart mating portion 72 of the counterpart connector 70 is inserted into the mating space 57 to start mating. At this time, the counterpart protrusions 73 provided on the counterpart mating portion 72 are inserted into the cam grooves 45 of the slide piece 40 through the openings 59 of the frame 11.

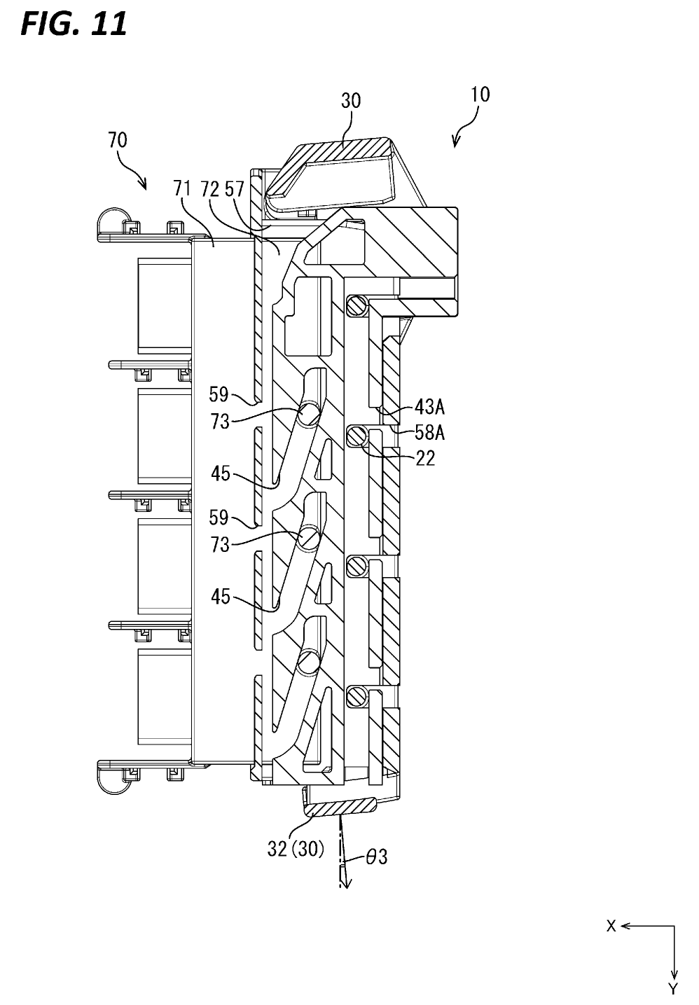

In a half-mated state of the connector 10 and the counterpart connector 70, the lever 30 is operated from the second operating angle to the third operating angle indicated as θ3 in FIG. 11 relative to the frame 11, to slide the slide piece 40 in the width direction Y and insert the counterpart protrusions 73 fully into the cam grooves 45. In other words, the third operating angle is the mating completed angle of the lever 30 at which mating between the connector 10 and the counterpart connector 70 is completed. Since the cam grooves 45 provided in the slide piece 40 are inclined to the width direction Y toward the rear, as a result of the slide piece 40 sliding in the width direction Y (downward in FIG. 11) in response to operating the lever 30 to the third operating angle, the counterpart mating portion 72 is pulled into the mating space 57.

In this embodiment, the third operating angle is the angle when the lever 30 is rotated such that the line segment passing through the rotation shaft 33 and the approximate center in the front-rear direction X of the connecting portion 32 is approximately 5 degrees relative to the width direction Y (indicated as θ3 in FIG. 11). In other words, the third operating angle of the lever 30 is larger than the first operating angle and smaller than the second operating angle relative to the width direction Y (θ1 < θ3 < θ2). Therefore, when mating the connector 10 with the counterpart connector 70, the lever 30 is operated by pushing it toward the frame 11. In other words, the operating direction of the lever 30 differs between the process of assembling the split housings 20 to the frame 11 and the process of mating the connector 10 with the counterpart connector 70, so that the operator can easily distinguish the operation of the lever 30 in each process.

As shown in FIG. 11, when the lever 30 is operated to the third operating angle relative to the frame 11, mating between the connector 10 and the counterpart connector 70 is completed. As a result of the slide piece 40 being set to a third position, the cam grooves 45 are displaced from the openings 59 in the width direction Y while the second insertion grooves 43 remain displaced from the first insertion grooves 58 in the width direction Y. Accordingly, the frame 11 can prevent the counterpart protrusions 73 from coming out of the cam grooves 45 while holding the protrusions 22 of the split housings 20 in the holding groove 44.

Moreover, as shown in FIG. 12, when the lever 30 is operated to the third operating angle relative to the frame 11, the locking piece 16 of the lever locking portion 15 is inserted into the lever-side locked portion 35 provided in the connecting portion 32 of the lever 30, thereby holding the lever 30 at the third operating angle. In the mating completed state, the tip of the counterpart mating portion 72 of the counterpart connector 70 abuts against the partition wall portions 53 in the mating space 57, preventing the counterpart connector 70 from advancing.

### Functions and Effects of Embodiments

The above-described connector 10 according to this embodiment provides the following effects.

In the connector 10, when the operator operates the lever 30 from the first operating angle to the second operating angle and the split housings 20 are assembled to the frame 11, the slide piece 40 prevents the split housings 20 from coming off the frame 11, and mating with the counterpart connector 70 is allowed. Hence, the split housings 20 are prevented from coming off the frame 11 before the assembled connector 10 is mated with the counterpart connector 70, with it being possible to improve operator workability.

In the connector 10, when the lever 30 is at the second operating angle, the cam grooves 45 of the slide piece 40 match the openings 59 in position in the width direction Y, to allow the split housings 20 to mate with the counterpart connector 70. When the lever 30 is moved from the second operating angle to the third operating angle, the cam grooves 45 are displaced from the openings 59 in the width direction while the first insertion grooves 58 remain displaced from the second insertion grooves 43 in the width direction Y, to prevent the counterpart protrusions 73 of the counterpart connector 70 from coming out of the cam grooves 45. This allows the operator to, by operating the lever 30, simultaneously prevent the split housings 20 from coming off the frame 11 and maintain mating with the counterpart connector 70, thus further improving operator workability.

After the split housings 20 are assembled to the frame 11, the operating direction of the lever 30 in the process of mating the connector 10 with the counterpart connector 70 is opposite to the direction in the case of assembling the split housings 20 to the frame 11. As a result, the operator can easily distinguish the operation in each process and operate intuitively.

In the process of assembling the split housings 20 to the frame 11 and the process of mating the connector 10 with the counterpart connector 70, the slide piece 40 slides in the opposite direction and by an amount corresponding to a different operating angle. Therefore, in the slide piece 40, when operating the lever 30 from the second operating angle to the third operating angle, both the displacement in the width direction Y between the second insertion grooves 43 and the first insertion grooves 58 and the displacement in the width direction Y between the cam grooves 45 and the openings 59 can be achieved without increasing the dimension in the width direction Y of the plate-shaped portion 41. This suppresses an increase in the dimension in the width direction Y of the plate-shaped portion 41, and consequently suppresses an increase in the size of the connector 10.

In a state in which mating between the connector 10 and the counterpart connector 70 is completed, locking the lever 30 by the lever locking portion 15 prevents the lever 30 from rotating from the third operating angle, i.e., the mating completed angle, to the second operating angle, thereby preventing de-mating from the counterpart connector 70.

The split housings 20 accommodated in the accommodation space 55 are held not only by the slide piece 40 but also by the lock arms 54 and thus are more securely prevented from coming off the frame 11.

### Other Embodiments

The following modifications can be made to the above embodiment. The above embodiment and the modifications described below may be combined unless they are technically inconsistent.

In the above embodiment, the frame 11 has the openings 59 at the front end, and when the slide piece 40 is at the second position, the cam grooves 45 of the slide piece 40 match the openings 59 in position in the width direction Y, allowing mating with the counterpart connector 70. Alternatively, the frame 11 may not have the openings 59 at the front end, as long as mating with the counterpart connector 70 is allowed when the slide piece 40 is at the second position.

In the above embodiment, the opening of the second insertion groove 43B of the slide piece 40 is located forward of the first insertion groove 58B. Alternatively, the slide piece 40 may have no second insertion groove 43B, and the openings of all second insertion grooves 43 may be located rearward of the first insertion grooves 58B of the frame 11, as with the second insertion grooves 43A.

In the above embodiment, four split housings 20 are accommodated in the frame 11. The number of split housings 20 is, however, not limited to four and may be determined depending on the intended use of the connector 10.

In the above embodiment, the frame 11 includes the lever locking portion 15 for locking the lever 30 operated to the third operating angle. The lever locking portion 15 may be any structure capable of locking the lever 30 operated to the third operating angle, and does not necessarily need to be provided on the side wall portions 52 of the frame 11. The frame 11 may include no lever locking portion 15.

In the above embodiment, the connector 10 includes the lock arms 54 in the accommodation space 55. Alternatively, the connector 10 may include no lock arms 54 in the accommodation space 55.

From the foregoing, it will be appreciated that various exemplary embodiments of the present disclosure have been described herein for purposes of illustration, and that various modifications may be made without departing from the scope and spirit of the present disclosure. Accordingly, the various exemplary embodiments disclosed herein are not intended to be limiting, with the true scope and spirit being indicated by the following claims.

What is claimed is:

1. A connector comprising:
a plurality of split housings that are mateable with a counterpart connector on a front side in a front-rear direction;
a frame including an accommodation space for accommodating the plurality of split housings arranged in a width direction that intersects the front-rear direction;
a slide piece held slidably in the width direction relative to the frame; and
a lever that slides the slide piece in the width direction,
wherein the split housings are accommodated in the accommodation space with a front side to be mated with the counterpart connector protruding from the frame,
the split housings include protrusions provided in an up-down direction,
the frame includes first insertion grooves provided on a rear end side and extending in the front-rear direction,
the slide piece includes second insertion grooves provided on a rear end side and extending in the front-rear direction,
when the lever is at a first operating angle relative to the frame, the second insertion grooves match the first insertion grooves in position in the width direction, to allow the protrusions to be inserted into the first insertion grooves and the second insertion grooves and the split housings to be accommodated in the accommodation space, and
when the lever is at a second operating angle relative to the frame, the second insertion grooves are displaced from the first insertion grooves in the width direction, to prevent the protrusions from coming out of the first insertion grooves and the second insertion grooves and allow the split housings to mate with the counterpart connector on the front side.

2. The connector according to claim 1, wherein the frame includes openings that are provided on a front end side and into which counterpart protrusions of the counterpart connector are to be inserted,
the slide piece includes groove portions that are provided on a front end side and into which the counterpart protrusions are to be inserted,
when the lever is at the second operating angle, the groove portions match the openings in position in the width direction, to allow the counterpart protrusions to be inserted into the openings and the groove portions and the split housings to mate with the counterpart connector, and
when the lever is moved from the second operating angle to a third operating angle relative to the frame, the groove portions are displaced from the openings in the width direction while the first insertion grooves remain displaced from the second insertion grooves in the width direction, to prevent the counterpart protrusions from coming out of the openings and the groove portions.

3. The connector according to claim 2, wherein the lever is rotatable in the front-rear direction about a rotation shaft provided on one end side in the width direction of the frame,
the second operating angle is larger than the first operating angle relative to the frame, based on the width direction, and
the third operating angle is larger than the first operating angle and smaller than the second operating angle, based on the width direction.

4. The connector according to claim 3, wherein the slide piece includes: a plate-shaped portion extending in the width direction and provided with the second insertion grooves on the rear end side and the groove portions on the front end side; and an engagement groove extending from the plate-shaped portion in the front-rear direction, and
the lever includes an engagement shaft that engages with the engagement groove to convert rotation of the lever about the rotation shaft into sliding motion of the plate-shaped portion in the width direction.

5. The connector according to claim 2, wherein the frame includes a lever locking portion that locks the lever at the third operating angle.

6. The connector according to claim 1, wherein the frame includes lock arms that engage with the split housings accommodated in the accommodation space.
